(19) United States
(12) Patent Application Publication
(10) Pub. No.: US 2026/0246336 A1
(43) Pub. Date: Aug. 20, 2026

(54) AIR COOLING SYSTEM FOR GAS POWERED GENERATOR

(71) Applicant: RV Mobile Power LLC, Columbus, OH (US)

(72) Inventor: Liu You Zhong, Chongqing (CN)

(73) Assignee: RV Mobile Power LLC, Columbus, OH (US)

(21) Appl. No.: 19/056,341

(22) Filed: Feb. 18, 2025

(51) Int. Cl. H02K 7/18; F01N 3/05; F01P 5/02; H02K 5/20; H02K 9/18

(52) U.S. Cl. CPC H02K 7/1815; F01N 3/05; F01P 5/02; H02K 5/207; H02K 9/18; H02K 2205/09

(57) ABSTRACT

Disclosed herein are various embodiments for a gas powered electric generator and related cooling systems comprising a combustion engine, a muffler connected to the combustion engine, an engine plenum enclosing the combustion engine, an exhaust plenum enclosing the muffler and attached to the engine plenum, an exhaust plenum outlet positioned on a bottom side of the exhaust plenum, and a fan positioned to force cooling air through the engine plenum, the exhaust plenum, and exhausted downwardly out of the exhaust plenum outlet.

### BACKGROUND

Gas-powered engines in generators produce significant amounts of heat during operation due to combustion and mechanical friction. If this heat isn't managed, it can cause the engine to overheat, leading to severe damage such as warped components, melted parts, or complete engine failure. Cooling systems—either air-cooled or liquid-cooled—are essential to maintain an optimal temperature for the engine, ensuring its longevity, efficiency, and safe operation. Proper cooling also helps to avoid performance issues, such as loss of power or reduced fuel efficiency, which can occur when the engine overheats.

### BRIEF DESCRIPTION OF THE DRAWINGS

These drawings illustrate certain aspects of some of the embodiments of the present disclosure and should not be used to limit or define the disclosure.

FIG. 1 is a front perspective view of a gas powered generator in accordance with some embodiments of the present disclosure.

FIG. 2 is a front perspective view of a gas powered generator where the front access door has been removed in accordance with some embodiments of the present disclosure.

FIG. 3 is a bottom perspective view of a gas powered generator and indicates the location of DETAIL A in accordance with some embodiments of the present disclosure.

FIG. 4 is a detailed view of DETAIL A shown in FIG. 3 in accordance with some embodiments of the present disclosure.

FIG. 5 is a front perspective view of a gas powered generator where the top cover has been removed and indicates the location of DETAIL B in accordance with some embodiments of the present disclosure.

FIG. 6 is a detailed view of DETAIL B shown in FIG. 5 in accordance with some embodiments of the present disclosure.

FIG. 7 is a top perspective view of a gas powered generator where the top cover has been removed in accordance with some embodiments of the present disclosure.

FIG. 8 is a rear perspective view of a gas powered generator where the top cover has been removed in accordance with some embodiments of the present disclosure.

FIG. 9 is a top plan view of a gas powered generator where the top cover, exhaust plenum and mounting plate have been removed in accordance with some embodiments of the present disclosure.

FIG. 10 is a left side perspective view of a gas powered generator where the top cover and the exhaust plenum have been removed in accordance with some embodiments of the present disclosure.

FIG. 11 is a left side projection view of a gas powered generator where the top cover, exhaust plenum, and muffler have been removed in accordance with some embodiments of the present disclosure.

### DETAILED DESCRIPTION

5 gas powered electric generator

10 bottom pan

20 top cover

30 latch

40 front access door

50 manual pull start

60 control panel

70 engine cover

80 cooling vent inlets

90 front cooling channel inlet

95 front cooling gap inlet

100 bottom plate

110 exhaust tail pipe

115 muffler bellow

120 cooling air exhaust opening

130 exhaust plenum outlet

140 exhaust plenum

150 mounting plate

152 top rib

154 side rib

160 engine plenum

168 fan plenum

169 axial fan

170 exhaust plenum mounting flange

180 engine plenum mounting flange

190 engine intermediary flange

200 exhaust intermediary flange

205 seal

220 inverter

221 heat sinks

230 starter motor

240 muffler

250 exhaust coupler

260 forced convection channel (muffler)

300 combustion engine

320 forced convection channel (engine)

340 engine plenum bottom

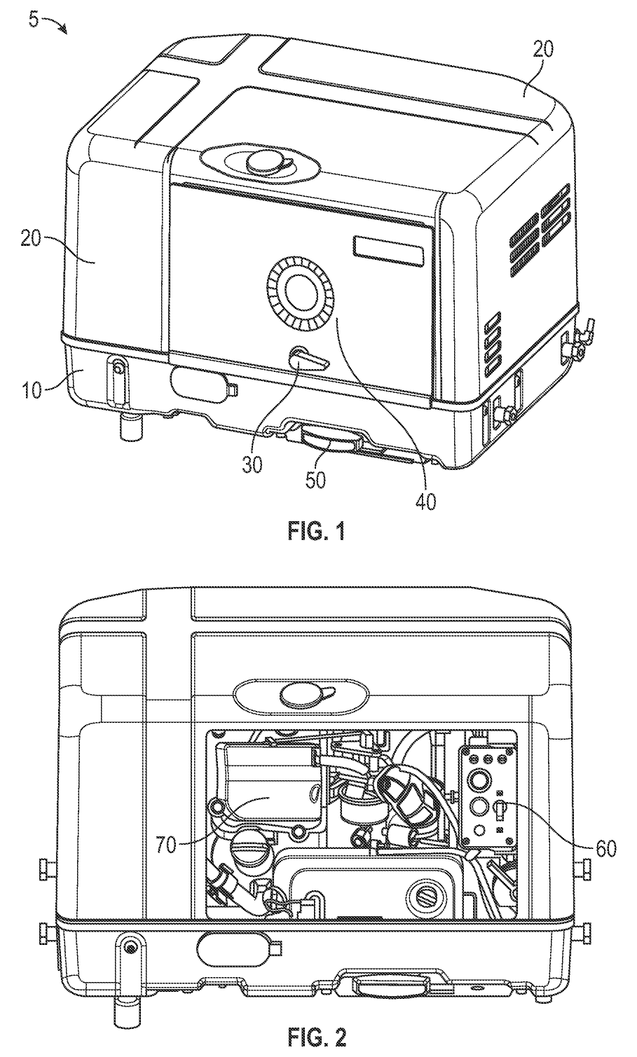

FIG. 1 is a front perspective view of an embodiment of a gas powered generator 5 equipped with any number of different embodiments of the cooling system in accordance with some embodiments of the present disclosure. As used herein, the term ‘gas’ is used to represent any combustible fuel that can be burned in a combustion engine including but not limited to: gasoline, diesel fuel, propane, natural gas, hydrogen, or similar combustible fuels. A bottom pan 10 may be used to form the bottom portion which may then be connected to a top cover 20 may cover the sides and top of the internal generator components and may cover all of the components entirely except for a front side portion of the top cover 20 which may be removed to have an access door 40 which can be opened and closed using a latch 30 (or any other mechanical/electromechanical means). Here in the front portion of the generator 5 may be the location for the manual pull start 50.

FIG. 2 illustrates a gas powered generator 5 where the front access door 40 has been removed so that some of the internal components of the generator 5 can be seen. A control panel 60 may be positioned behind the front access door 40 and may be used to provide at least one method for controlling the operations of the generator 5 including starting/stopping the generator, priming the combustion engine, warning lights for low oil, a breaker for turning on/off the power output. An engine cover 70 may also be positioned behind the front access door 40 and may be positioned to cover a top portion of the combustion engine (which is not viewable here as it is covered by the engine plenum and engine cover 70, described and shown further below). The engine cover 70 may provide thermal insulation between the combustion engine and the internal areas of the top cover 20 and may be a heat shield.

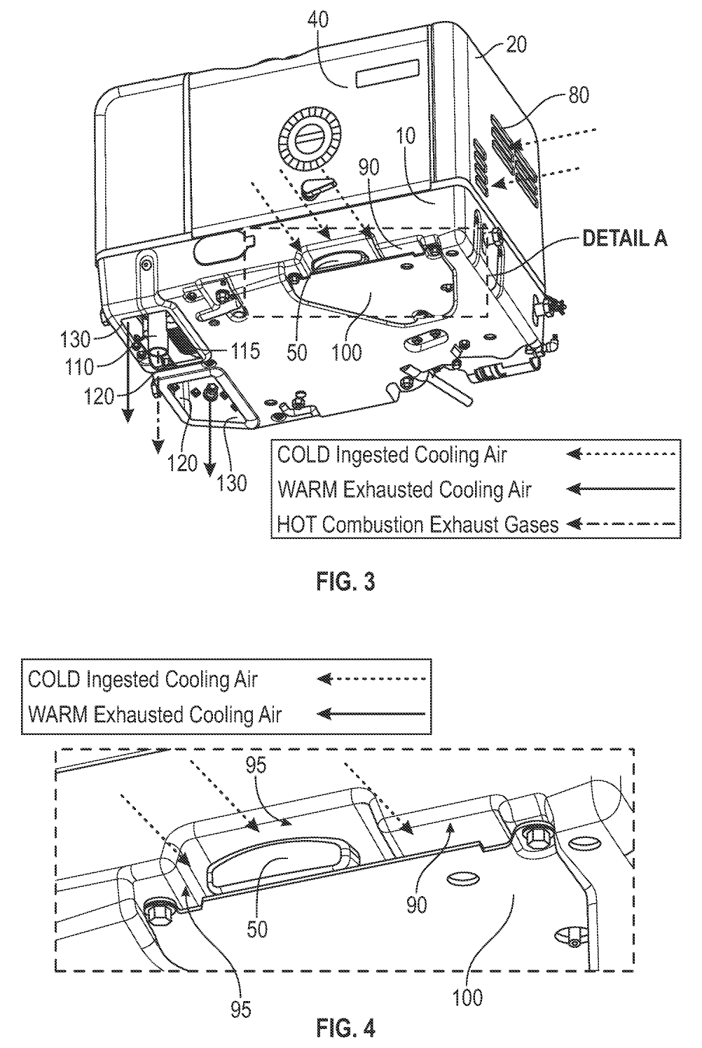

FIG. 3 is a bottom perspective view of a gas powered generator 5 and indicates the location of DETAIL A in accordance with some embodiments of the present disclosure. The bottom pan 10 may have a front cooling inlet channel 90 positioned at the front of the bottom pan 10 and below the front access door 40 so that cooling air can be ingested through the front cooling inlet channel 90. The channel 90 may be adjacent to the manual pull start 50 and in some embodiments may also surround at least a portion of the manual pull start 50. A bottom plate 100 may be positioned underneath the manual pull start 50 so that the channel 90 may be defined by the space between the bottom plate 100 and the bottom pan 10. The bottom plate 100 may be the lowest surface on the generator 5.

Cooling vent inlets 80 can also ingest cooling air into the generator 5 by allowing ambient air to pass through the top cover 20. In some embodiments the cooling vent inlets 80 are positioned on a side of the generator 5, sometimes on a side vertical surface of the top cover 20. On the opposing side of the generator 5, a cooling air exhaust opening 120 may be positioned on a bottom surface of the pan 10 to allow the warm exhausted cooling air to exit the generator 5. In some embodiments, the cooling vent inlets 80 on placed on the opposite side of the generator 5 as the cooling air exhaust opening 120. Further, the front cooling channel inlet 90 may also be positioned on the opposite side of the generator 5 as the cooling air exhaust opening 120. Thus, the front cooling channel inlet 90 may be positioned on a front surface of the bottom pan 10 while being placed near the side of the generator 5 that contains the cooling vent inlets 80. While in this particular view, the cooling vent inlets 80 are shown on the right hand side of the generator 5 while the cooling air exhaust opening 120 is shown on the left hand side but this is not required. The reverse of this orientation could also be done where the cooling vent inlets 80 are shown on the left hand side of the generator 5 while the cooling air exhaust opening 120 is shown on the right hand side.

As will be described further below, the cooling air exhaust opening 120 may align with an exhaust plenum outlet 130 so that the cooling air can be forced downwardly and out of the bottom pan 10 and top cover 20. This cooling air is separate and different from the hot combustion exhaust gases which are the by-product of the combustion process and may contain any different number of different gases in varying combinations depending on the type of fuel that is being burned. These hot combustion exhaust gases may exit the exhaust tail pipe 110 which may pass through both the cooling air exhaust opening 120 and the exhaust plenum outlet 130. The exhaust tail pipe 110 may connect to a muffler bellow 115 which may be positioned above the cooling air exhaust opening 120 and the exhaust plenum outlet 130. The cooling air may pass over both the exhaust tail pipe 110 as well as the muffler bellow 115 as it exits the bottom pan 10 (through the cooling air exhaust opening 120 and the exhaust plenum outlet 130) and becomes warm exhausted cooling air. The warm exhausted cooling air may exit the bottom pan 10 (through the cooling air exhaust opening 120 and the exhaust plenum outlet 130) at a direction that is substantially vertical and downward, and sometimes perpendicular to a bottom surface of the bottom pan 10 as well as perpendicular to the bottom cover 100.

FIG. 4 is a detailed view of DETAIL A shown in FIG. 3 providing a closer look at the front cooling channel inlet 90 in accordance with some embodiments of the present disclosure. Optionally, a front cooling gap inlet 95 can be used to surround portions of the manual pull start 50 with additional area to ingest ambient cooling air into the bottom pan 10. The front cooling gap inlets 95 may be defined as the area between the bottom pan 10 and the manual pull start 50. Some front cooling gap inlets may be defined as the area between the bottom pan 10 and the bottom plate 100. The bottom plate 100 may connect to the bottom surface of the bottom pan 10 so that areas between the plate 100 and pan 10 may define front cooling channel inlet(s) 90 as well as front cooling gap inlet(s) 95. The cold ingested cooling air may enter the channel inlet 90 and gap inlet 95 in a substantially horizontal direction that is perpendicular to the front surface of the bottom pan 10 as well as the front access door 40.

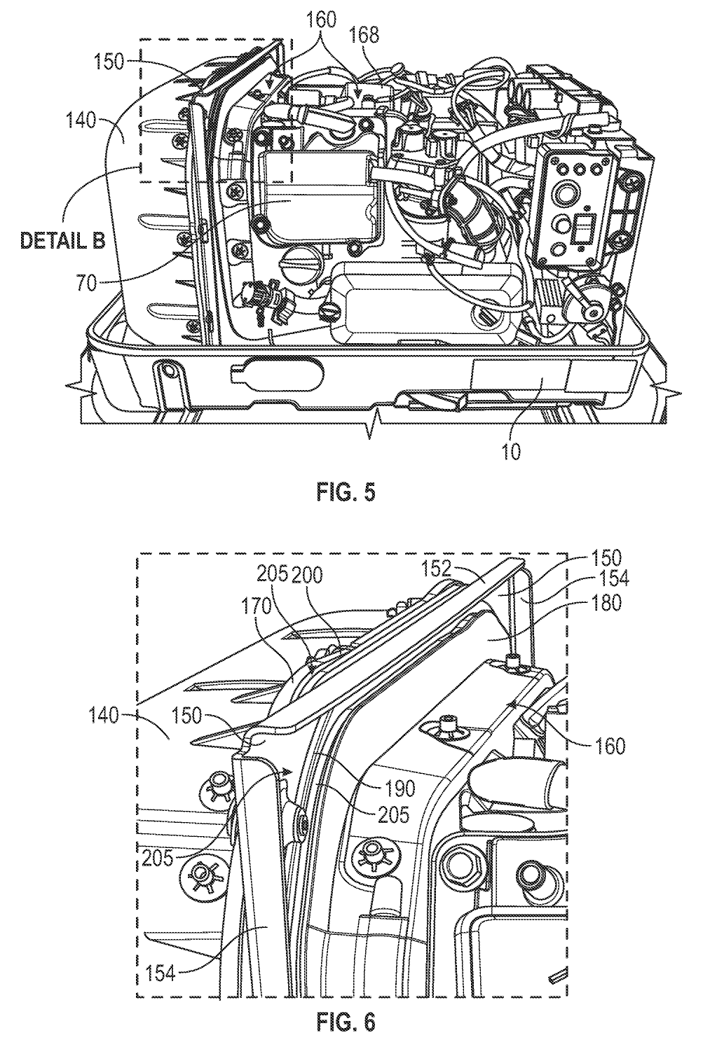

FIG. 5 is a front perspective view of a gas powered generator where the top cover 20 has been removed and indicates the location of DETAIL B in accordance with some embodiments of the present disclosure. A mounting plate 150 may extend vertically and upwardly from the bottom pan 10 and attach with an exhaust plenum 140 on one side of the plate 150 while attaching with an engine plenum 160 on the opposing side. A fan plenum 168 may connect to the engine plenum 160 so that the combustion engine and the fan are both contained within the combination of the fan plenum 169 and engine plenum 160. An engine cover 70 may be positioned to cover a portion of the combustion engine that is not contained within the engine plenum 160.

FIG. 6 is a detailed view of DETAIL B shown in FIG. 5 in accordance with some embodiments of the present disclosure. The mounting plate 150 may contain a pair of vertical edges which may each contain one or more side ribs 154. The side ribs 154 may comprise vertical shelves which extend horizontally away from the mostly vertical mounting plate 150. The mounting plate 150 may also contain a top edge which may contain one or more top ribs 152. The top ribs 152 may comprise horizontal shelves which extend away from the mostly vertical mounting plate 150. The exhaust plenum 140 may contain an exhaust plenum mounting flange 170 which may provide a substantially flat perimeter around the exhaust plenum 140 so that it may connect securely and seal gases between the exhaust plenum 140 and the mounting plate 150. The engine plenum 160 may contain an engine plenum mounting flange 180 which may provide a substantially flat perimeter around the engine plenum 160 so that it may connect securely and seal gases between the engine plenum 160 and the mounting plate 150.

An optional engine intermediary flange 190 may be used with an optional gaseous seal 205 placed between the engine intermediary flange 190 and the mounting plate 150 as well as optionally between the engine intermediary flange 190 and the engine plenum 160. Similarly, an optional exhaust intermediary flange 200 may be used with an optional gaseous seal 205 placed between the exhaust intermediary flange 200 and the mounting plate 150 as well as optionally between the exhaust intermediary flange 200 and the exhaust plenum 140. In this way, each plenum 140 and 160 may be gaseously secured to the mounting plate 150 and thus gaseously secured together. This arrangement has been discovered to further secure the plenums 140 and 160 together so that they are gaseously sealed together with only minimal leaks of the cooling air escaping the plenums 140 and 160 prior to being exhausted. The mounting plate 150 may not be used in some embodiments, where instead the exhaust plenum mounting flange 170 would instead mount directly to the engine plenum mounting flange 180.

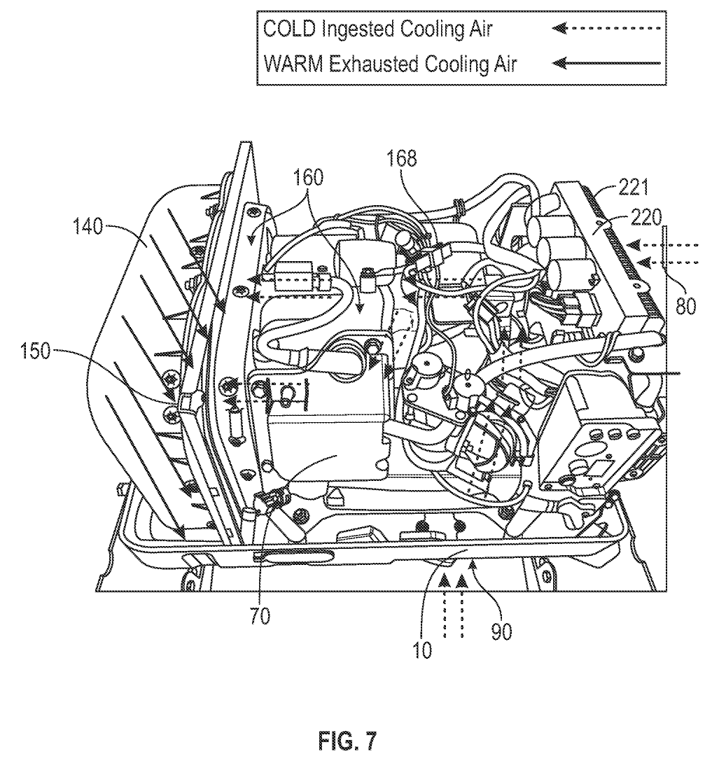

FIG. 7 is a top perspective view of a gas powered generator where the top cover 20 has been removed in accordance with some embodiments of the present disclosure. The cold cooling air may be ingested at the front portion of the bottom pan 10 at the front cooling channel inlet 90 and once inside may travel inwardly towards the back side of the generator. If the generator 5 includes an inverter 220 then the cooling air ingested from the front cooling channel inlet 90 may then travel between the fan plenum 168 and the inverter 220. The cooling air may travel along the backside of the inverter 220 (i.e. the opposite side as the heat sinks 221). If an inverter 220 is used, then cooling air that is ingested at the cooling vent inlets 80 may be drawn over the heat sinks 221 of the inverter 220 prior to entering the fan plenum 168.

Once the cooling air enters the fan plenum 168 it may be forced into the engine plenum 160 where it may separate into several different flows that encircle the combustion engine. The fan plenum 168 is preferably in sealed gaseous communication with the engine plenum 160. The cooling air may then exit the engine plenum 160 and pass through the mounting plate 150 before entering the exhaust plenum 140 and beginning to travel downward horizontally. The cooling air preferably travels substantially horizontally through the fan plenum 168 and the engine plenum 160 but may switch to a substantially vertical direction once entering the exhaust plenum 140 and passing over the muffler and exhaust (shown in detail below).

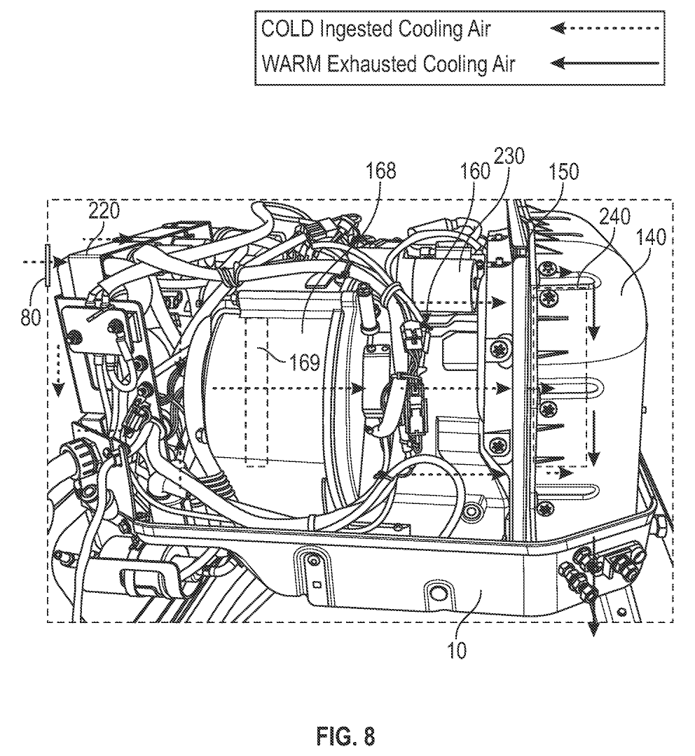

FIG. 8 is a rear perspective view of a gas powered generator where the top cover 20 has been removed in accordance with some embodiments of the present disclosure. A starter motor 230 may be attached to the outside of the engine plenum 160 and may be thermally insulated from the interior gases of the engine plenum 160. The cooling air ingested from the inlet vents 80 may be drawn over the top surface and bottom surface of an optional inverter 220 prior to travelling along the back side of the inverter 220 and finally ingested into the fan plenum 168. An axial fan 169 may be placed within the fan plenum 168 and may be connected to the axle of the combustion engine, either directly or through a gear box. The cooling air preferably travels substantially horizontally through the fan plenum 168 and the engine plenum 160 but may switch to a substantially vertical direction while passing over the muffler 240 and exhaust (shown in detail below).

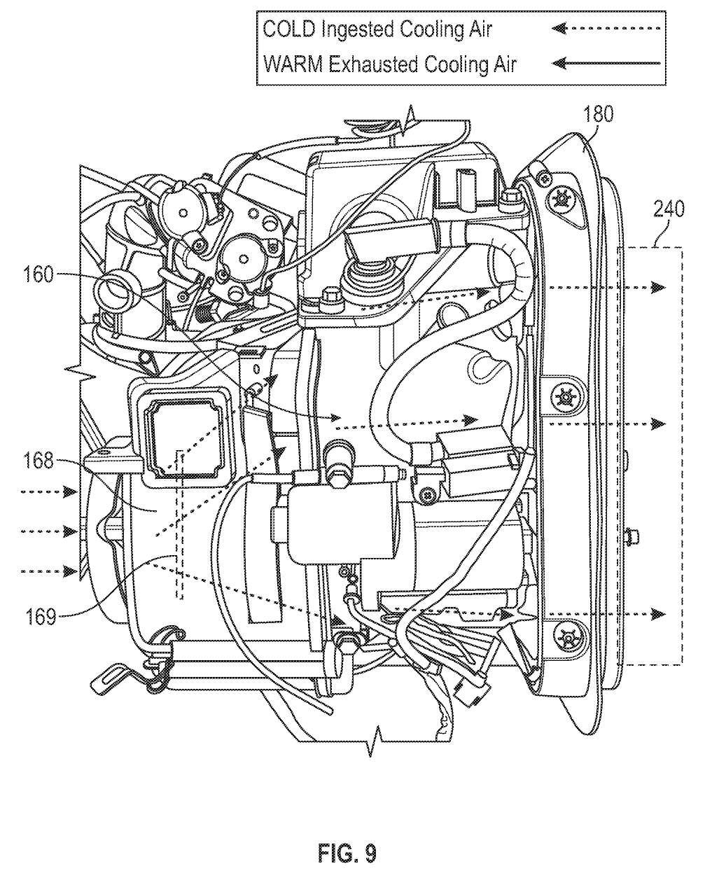

FIG. 9 is a top plan view of a gas powered generator where the top cover 20, exhaust plenum 140 and mounting plate 150 has been removed in accordance with some embodiments of the present disclosure. The cooling air coming from the intake(s) may be condensed into an area about the size of the fan 169 prior to being ingested into the fan plenum 168 where it may be forced by the fan 169 into several different flows moving through the engine plenum 160. Once passing through the engine plenum mounting flange 180 (or mounting plate 150) the cooling air may spread across a larger area than the fan 169 and would be large enough to pass over the majority of, if not the entire muffler 240.

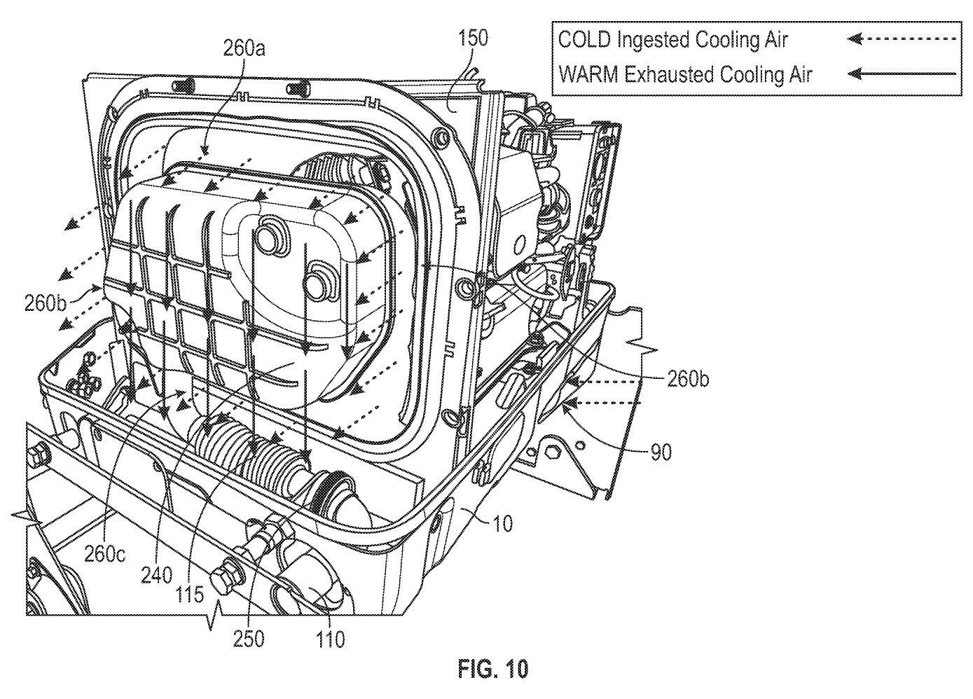

FIG. 10 is a left side perspective view of a gas powered generator where the top cover 20 and the exhaust plenum 140 have been removed in accordance with some embodiments of the present disclosure. One or more forced convection channels 260 may be defined between the various surfaces of the muffler 240 and the surrounding exhaust plenum 140 (removed for clarity here). The forced convection channel 260 can also be defined as the space between the muffler 240 and the mounting plate 150 as it wraps around the muffler 240. A single forced convection channel 260 may be used to surround the entire muffler 240, or alternatively a plurality of forced convection channels 260 may be positioned along the perimeter of the muffler 240. In some embodiments, a top channel 260a is placed at the top of the muffler 240, two side channels 260b are placed at the sides of the muffler, and a bottom channel 260c may also be placed along the bottom.

Once travelling over the perimeter of the muffler 240, the cooling air may then turn approximately 90 degrees to begin travelling downward and vertically along the backside (the opposite side of the combustion engine) of the muffler 240. The cooling air may then travel along the muffler bellow 115 as well as the exhaust tail pipe 110 which may be connected to the muffler bellow 115 using an exhaust coupler 250 which allows the tail pipe 110 to connect to the muffler below 110 at a variety of different angles so that the tail pipe 110 can be run vertically down out of the bottom of the bottom pan 10 or (as shown here) may be run horizontally out of the side of the bottom pan 10.

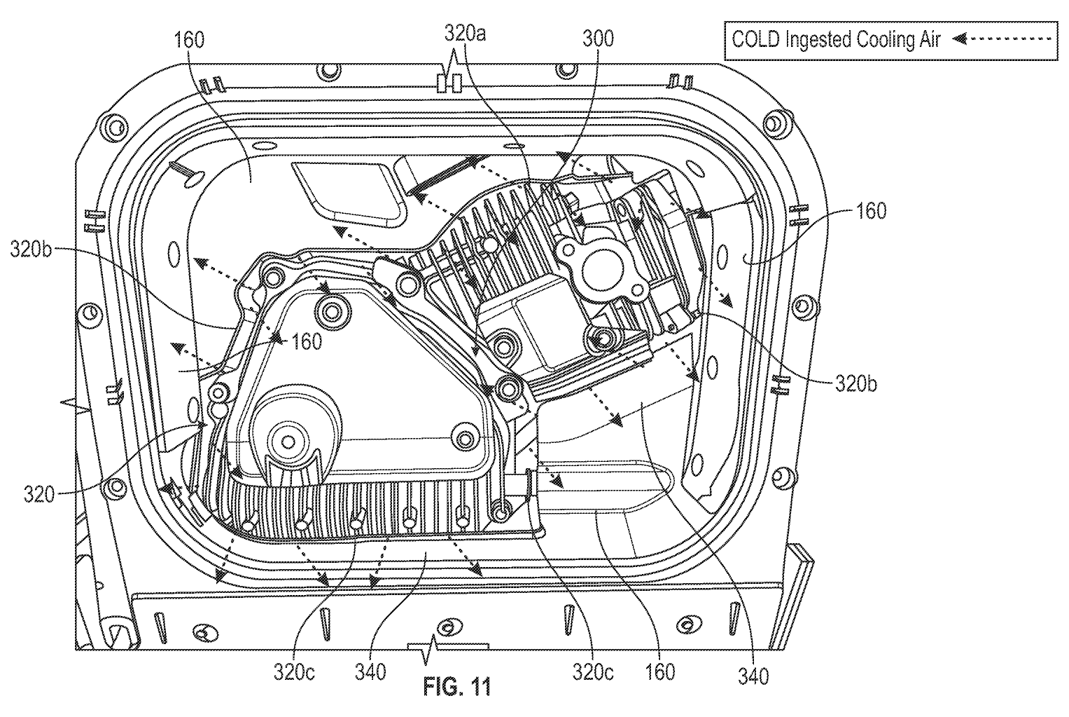

FIG. 11 is a left side projection view of a gas powered generator where the top cover 20, exhaust plenum 140, and muffler 240 have been removed in accordance with some embodiments of the present disclosure. The combustion engine 300 may be enclosed by the engine plenum 160 on each of the top, bottom, and sides of the combustion engine 300. One or more forced convection channels 320 may be defined as the space between the engine plenum 160 and the combustion engine 300. A single forced convection channel 320 may be used to surround the entire combustion engine 300, or alternatively a plurality of forced convection channels 320 may be positioned along the perimeter of the combustion engine 300. In some embodiments, a top channel 320a may be placed at the top of the combustion engine 300, two side channels 320b may be placed at the sides of the engine 300, and a bottom channel 320c may also be placed along the bottom.

An engine plenum bottom 340 may provide the bottom surfaces for the engine plenum 160 that are below the combustion engine 300, so that the area between the engine plenum bottom 340 and the combustion engine 300 may define one or more forced convection channels 320 to cool the bottom side of the combustion engine 300. The combustion engine 300 may have an output drive shaft that is rotated by the combustion engine 300 and this output drive shaft may be mechanically connected to the fan 169 so that fan 169 would be considered an axial fan and would be driven by the combustion engine 300. The output drive shaft may be the same shaft that drives the alternator which converts the mechanical energy of the combustion engine 300 to electrical energy output by the generator 5 (sometimes after passing through the inverter 220, if used).

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

I claim:

1. A gas powered electric generator comprising:
a combustion engine;
a muffler connected to the combustion engine;
an engine plenum enclosing the combustion engine;
an exhaust plenum enclosing the muffler and attached to the engine plenum;
an exhaust plenum outlet positioned on a bottom side of the exhaust plenum; and
a fan positioned to force cooling air through the engine plenum, the exhaust plenum, and exhausted downwardly out of the exhaust plenum outlet.

2. The gas powered electric generator of claim 1 further comprising:
a muffler bellow attached to the muffler and positioned above the exhaust plenum outlet.

3. The gas powered electric generator of claim 2 further comprising:
an exhaust tail pipe connected to the muffler below and positioned above the exhaust plenum outlet.

4. The gas powered electric generator of claim 1 further comprising:
a forced convection channel surrounding the combustion engine.

5. The gas powered electric generator of claim 1 further comprising:
a forced convection channel between the combustion engine and the engine plenum.

6. The gas powered electric generator of claim 1 further comprising:
a forced convection channel surrounding the muffler.

7. The gas powered electric generator of claim 1 further comprising:
an inverter positioned adjacent to cooling vent inlets such that the fan is further positioned to draw cooling air into the cooling vent inlets and over the inverter prior to entering the engine plenum.

8. A gas powered electric generator comprising:
a bottom pan having a front portion and a bottom portion;
a front cooling channel inlet positioned on the front portion of the bottom pan;
a cooling air exhaust opening positioned on the bottom portion of the bottom pan;
an engine plenum enclosing a combustion engine;
a vertical mounting plate attached to the engine plenum;
an exhaust plenum enclosing a muffler and attached to the vertical mounting plate;
an exhaust plenum outlet positioned on a bottom side of the exhaust plenum and aligned with the cooling air exhaust opening in the bottom pan; and
a fan positioned to force cooling air into the front cooling channel inlet, through the engine plenum, the exhaust plenum, and exhausted downwardly out of the exhaust plenum outlet and the cooling air exhaust opening in the bottom pan.

9. The gas powered electric generator of claim 8 further comprising:
a top cover which attaches to the bottom pan;
a cooling vent inlet positioned on the top cover; and
an inverter positioned adjacent to the cooling vent inlet such that the fan further draws cooling air into the cooling vent inlet and over the inverter prior to entering the fan plenum.

10. The gas powered electric generator of claim 8 further comprising:
a muffler bellow attached to the muffler and positioned above the exhaust plenum outlet; and
an exhaust tail pipe connected to the muffler below and positioned above the exhaust plenum outlet.

11. The gas powered electric generator of claim 8 further comprising:
a forced convection channel surrounding the combustion engine.

12. The gas powered electric generator of claim 8 further comprising:
an exhaust plenum mounting flange surrounding the exhaust plenum and attached to a first side of the mounting plate; and
an engine plenum mounting flange surrounding the engine plenum and attached to a second side of the mounting plate.

13. The gas powered electric generator of claim 8 further comprising:
a top rib extending horizontally from a top edge of the mounting plate; and
a pair of side ribs extending horizontally from opposing sides edges of the mounting plate.

14. The gas powered electric generator of claim 8 further comprising:
a manual pull start positioned underneath the bottom pan; and
a bottom plate positioned below the manual pull start.

15. The gas powered electric generator of claim 14 wherein:
the front cooling channel inlet is defined by a gap between the bottom pan and the bottom plate.

16. A gas powered electric generator comprising:
a cooling channel inlet;
an engine plenum enclosing a combustion engine to define an engine forced convection channel around the combustion engine;
an exhaust plenum enclosing a muffler to define a muffler forced convection channel around the muffler;
an exhaust plenum outlet positioned on a bottom side of the exhaust plenum; and
an axial fan positioned to force cooling air into the cooling channel inlet, through the engine forced convection channel, through the muffler forced convection channel, and exhausted downwardly out of the exhaust plenum outlet.

17. The gas powered electric generator of claim 16 further comprising:
a muffler bellow attached to the muffler and positioned above the exhaust plenum outlet.

18. The gas powered electric generator of claim 16 further comprising:
an inverter providing electrical output for the generator, and
wherein the axial fan is further positioned to draw cooling air over the inverter.

19. The gas powered electric generator of claim 18 further comprising:
a fan plenum surrounding the axial fan and positioned between the inverter and the engine plenum.

20. The gas powered electric generator of claim 16 wherein:
the cooling channel inlet is defined by a gap between a bottom plate and a bottom pan.
